(19) United States
(12) Patent Application Publication
(10) Pub. No.: US 2024/0208703 A1
(43) Pub. Date: Jun. 27, 2024

(54) Method for Applying a Coating Layer to a Packaging Material, and Coating Layer Application Device

(71) Applicant: ACE PACKAGING N.V., Diest (BE)

(72) Inventor: Dave STAPPAERTS, Diest (BE)

(21) Appl. No.: 18/556,545

(22) PCT Filed: Apr. 22, 2022
(86) PCT No.: PCT/IB2022/053774

§ 371 Date: Oct. 20, 2023

(30) Foreign Application Priority Data
Apr. 23, 2021 (BE) 2021/5319

(51) Int. Cl. B65D 65/42; B65D 33/01; B65D 85/34; B65D 85/36; B65D 85/76; C09D 191/08

(52) U.S. Cl. CPC B65D 65/42; B65D 33/01; B65D 85/34; B65D 85/36; B65D 85/76; C09D 191/08

(57) ABSTRACT

Method for applying a coating layer to a cellulose packaging material, comprising: providing a cellulose layer with a first side and a second side: providing a moving endless surface comprising a grid zone with a plurality of recesses: taking up a predetermined quantity of coating layer material in the plurality of recesses of the grid zone: retaining the predetermined quantity of coating layer material in the plurality of recesses: bringing the grid zone into contact with the first side of the cellulose layer: applying the predetermined quantity of coating layer material to the first side of the cellulose layer from the plurality of recesses: and forming a coating layer on the first side of the cellulose layer with the predetermined quantity of coating layer material.

### FIELD OF THE INVENTION

The invention relates to a method for applying a coating layer to a cellulose packaging material for the purpose of setting a moisture vapour permeability of the packaging material. The invention further relates to a grid roller for use in the method. The invention also relates to a coating layer application device for setting a moisture vapour permeability of a cellulose packaging material.

### BACKGROUND

A first known technique for applying a coating layer to a cellulose packaging material consists of spraying coating layer material onto the cellulose packaging material. Use is made here of a spray installation comprising one or more spray nozzles directed toward the cellulose packaging material. The spray installation carries coating layer material to the spray nozzles under pressure. The spray nozzles then spray the coating layer material onto the cellulose packaging material in order to form the coating layer. In other words, the spray nozzles atomize the coating layer material onto the cellulose packaging material. The spraying of coating layer material requires the coating layer material to have a low viscosity, meaning that the coating layer material in question must be runny. The coating layer material must for instance have a viscosity which corresponds with that of water under normal conditions. Such coating layer materials are expensive and difficult to manufacture. Such spray installations are further complex, high-maintenance and have a relatively limited productivity relative to a subsequent, second technique. This second known technique comprises the use of a rotary press with a rotatable cylinder. The cylinder is partially submerged in a container with coating layer material. The cylinder then rotates about an axis, whereby it takes up coating layer material from the container in continuous manner. Using a pressing cylinder, the cellulose packaging material is then pressed against the rotatable cylinder whereby the coating layer material is applied to the cellulose packaging material. The productivity of this second technique is considerably higher than the first technique, since the cellulose packaging material is carried along the rotatable cylinder at a higher speed. The quantity of coating layer material which is applied can however hardly be set. Such a rotary press can further be controlled to only limited extent. Reducing a pressure of the pressing cylinder on the paper will thus result in irregularities in the coating layer on the final cellulose packaging material. A further drawback of the rotary press is that it is impossible to apply a specific quantity of coating layer material in predetermined manner.

### SUMMARY OF THE INVENTION

Embodiments of the invention have the object of providing a method for applying a coating layer to a cellulose packaging material for the purpose of setting a moisture vapour permeability of the packaging material with an increased controllability. It is a second object of the invention to provide a coating layer application device with increased controllability.

According to a first aspect, the invention relates for this purpose to a method for applying a coating layer to a cellulose packaging material for the purpose of setting a moisture vapour permeability of the packaging material, comprising:
providing a cellulose layer with a first side and a second side;
providing a moving endless surface comprising a grid zone with a plurality of recesses;
taking up a predetermined quantity of coating layer material in the plurality of recesses of the grid zone;
retaining the predetermined quantity of coating layer material in the plurality of recesses;
bringing the grid zone into contact with the first side of the cellulose layer;
applying the predetermined quantity of coating layer material to the first side of the cellulose layer from the plurality of recesses; and
forming a coating layer on the first side of the cellulose layer with the predetermined quantity of coating layer material.

Because the plurality of recesses of the grid zone take up a predetermined quantity of coating layer material, for instance by a capillary action of the recesses, then retain this quantity of coating layer material and apply it to the cellulose layer, the quantity of coating layer material which is applied to the cellulose layer is always known. The quantity of coating layer material is moreover predeterminable. This is possible by changing a size of the recesses of the grid zone. This also means that the quantity of coating layer material can therefore always be changed beforehand and is thus controllable. Furthermore, the moisture vapour permeability of the packaging material is hereby also controllable in optimal manner.

The grid zone preferably comprises a first grid zone part and a second grid zone part comprising respectively a plurality of first recesses and a plurality of second recesses which take up, retain and apply respectively a first predetermined quantity of coating layer material and a second predetermined quantity of coating layer material, wherein the first predetermined quantity of coating layer material differs from the second predetermined quantity of coating layer material. Cellulose packaging materials are used in all manner of forms and applications. After forming the coating layer on the cellulose packaging materials these packaging materials are typically formed depending on the application of the cellulose packaging material. A bread bag can thus for instance be formed by folding the cellulose packaging material and then adhering it to corresponding sides.

A coating layer however prevents the adhesion of cellulose packaging material, whereby mutually adhered cellulose packaging materials come loose. This has an adverse effect on the quality of the finally assembled packaging material. A grid zone with a first and a second grid zone part which each take up, retain and apply a respective quantity of coating layer material has the advantage that the quantity of coating layer material in the respective grid zone parts is controllable, for instance depending on the intended object of the packaging material. This allows the quantity of applied coating layer material to be controlled locally in accordance with the intended object of the cellulose packaging material. Considerably more coating layer material can thus for instance be taken up, retained and applied in the first grid zone part than in the second grid zone part, or vice versa. According to the above stated example, the coating layer will adhere better where less coating layer material has been applied locally. It will be apparent on the basis of the above that the controllability improves further according to said preferred embodiment.

The moving endless surface is preferably further provided with a blank zone which applies no coating layer material to the first side of the cellulose layer. This allows the creation of zones on the cellulose packaging material where an adhesion is optimal.

A dimension of the plurality of recesses is preferably such that the coating layer has a weight lying in the range of 10-12 g/m², more preferably lying in the range of 8-10 g/m², most preferably lying in the range of 1-8 g/m². Research by the inventor has shown that the moisture vapour permeability of the coating layer is sigmoidally proportional to the applied quantity of coating layer material. A coating layer with a weight of 1-5 g/m² thus has an acceptable moisture vapour permeability and optimal adhesion characteristics. It will be apparent that the quantity of coating layer also depends on the type of cellulose layer, as will be further described below. Such a coating layer is furthermore cheaper compared to a coating layer wherein more coating layer material is applied. The inventor has further found that a coating layer with a weight of 10-12 g/m² approaches a minimal moisture vapour permeability in asymptotic manner. An optimal moisture vapour permeability is thus achieved when a coating layer with a weight of 10-12 g/m² is applied. Approaching the optimal moisture vapour permeability in asymptotic manner is understood to mean that application of a coating layer with a weight higher than 12 g/m² has almost no favourable effect on the moisture vapour permeability thereof.

Bringing the grid zone into contact with the first side of the cellulose layer preferably comprises pressing the first side of the cellulose layer against the grid zone of the moving endless surface. This improves the transfer of coating layer material from the grid zone to the cellulose layer. The coating layer is thus applied in improved manner.

The pressing is preferably performed by means of a pressing cylinder. This is deemed favourable because the coating layer thereby penetrates the cellulose layer still further.

The application of the predetermined quantity of coating layer material to the first side of the cellulose layer is preferably interrupted. This has a positive effect on the further processing of the cellulose layer. The cellulose layer is thus for instance better foldable or adherable at the position of the interruption.

The interruption of the application of the coating layer on the first side of the cellulose layer preferably comprises of an interruption in bringing the grid zone into contact with the first side of the cellulose layer. The interruption in bringing the grid zone into contact guarantees that no coating layer material is applied to the cellulose layer, whereby a quality of the final cellulose layer is optimally controlled. The interruption in bringing into contact is further preferably performed using a hopper mechanism which couples the pressing cylinder movably to a camshaft which is configured to convert a rotating movement thereof into an up and downward movement of the hopper mechanism, whereby the contact between the cellulose layer and the moving endless surface is interrupted.

The coating layer preferably comprises an oily compound, such as a paraffin or vegetable oil. The use of palm oil or soybean oil or mixtures thereof is for instance favourable.

The coating layer is preferably applied in a pattern. The pattern of the coating layer preferably comprises repetitive elements. The repetitive elements preferably have a zero-dimensional or one-dimensional form, such as dots, lines, circles. It is further possible for the repetitive elements to have other forms, such as zigzag lines, stepped forms, sine shapes, rectangles, squares, triangles. The repetitive elements further preferably have a fixed width. The repetitive elements are still more preferably situated at a uniform mutual distance, whereby a pattern of lines and intermediate spaces results. The perpendicular distance between the repetitive elements is more preferably a maximum of 4 times greater than the width of the repetitive elements. The perpendicular distance is still more preferably a maximum of 3 times or even a maximum of 2 times the width of the repetitive elements.

Taking up the predetermined quantity of coating layer material in the plurality of recesses of the grid zone preferably comprises taking up the coating layer material in the recesses in capillary manner.

The cellulose packaging material is preferably a cellulose packaging material for foods, such as bread, baked goods, vegetables, fruit, cheese or meat, or non-foods.

The moving endless surface is preferably a grid roller.

The coating layer preferably has a moisture vapour permeability lying between 15 and 200 g/m²/day, preferably between 15 and 180 g/m²/day, more preferably between 15 and 150 g/m²/day, still more preferably between 15 and 120 g/m²/day. The moisture vapour permeability is measured in accordance with DIN 53-122-1 at 25° C. and at 75% relative humidity. The vapour permeability is also known in the field as the MVTR (moisture vapour transmission rate). This low vapour permeability is favourable because it makes the cellulose layer an effective alternative to conventional plastics, which have a vapour permeability of about 15 g/m²/day. The further decrease of the MVTR appears to be partially related to the fact that the coating layer does not permeate through the whole cellulose layer. When permeating into the cellulose layer, the oil apparently creates hydrophobic pores, through which vapour diffuses and no longer adheres to the previously hydrophilic cellulose.

The method preferably further comprises providing a further moving endless surface which comprises a grid zone with a plurality of recesses; taking up a predetermined quantity of coating layer material in the plurality of recesses of the grid zone of the further moving endless surface; retaining the predetermined quantity of coating layer material in the plurality of recesses of the further moving endless surface; bringing the grid zone into contact with the second side of the cellulose layer; applying the predetermined quantity of coating layer material to the second side of the cellulose layer from the plurality of recesses of the further moving endless surface; and forming a further coating layer on the second side of the cellulose layer with the predetermined quantity of coating layer material.

According to a second aspect, the invention relates for this purpose to a coating layer application device for setting a moisture vapour permeability of a cellulose packaging material, comprising a moving endless surface for applying a coating layer to the cellulose packaging material comprising a cellulose layer with a first side and a second side, wherein the cellulose layer moves through the coating layer application device in a direction of movement, wherein the moving endless surface comprises a grid zone with a plurality of recesses which are configured to:
take up a predetermined quantity of coating layer material in the plurality of recesses of the grid zone;
retain the predetermined quantity of coating layer material in the plurality of recesses;
wherein the moving endless surface is placeable in the vicinity of/in contact with the first side of the cellulose layer and is further configured to:
apply the predetermined quantity of coating layer material to the first side of the cellulose layer from the plurality of recesses; and
form a coating layer on the first side of the cellulose layer with the predetermined quantity of coating layer material.

The skilled person will appreciate that similar advantages and objectives apply to the method and to the corresponding coating layer application device, mutatis mutandis.

The grid zone preferably comprises a first grid zone part and a second grid zone part comprising respectively a plurality of first recesses and a plurality of second recesses which take up, retain and apply respectively a first predetermined quantity of coating layer material and a second predetermined quantity of coating layer material, wherein the first predetermined quantity of coating layer material differs from the second predetermined quantity of coating layer material.

The coating layer application device is preferably configured to interrupt the application of the coating layer as seen in a direction transversely of the direction of movement of the cellulose layer.

The moving endless surface is preferably further provided with a blank zone which applies no coating layer material to the first side of the cellulose layer.

A dimension of the recesses is preferably such that the coating layer has a weight lying in the range of 10-12 g/m², more preferably lying in the range of 8-10 g/m², most preferably lying in the range of 1-8 g/m².

The coating layer application device preferably comprises a pressing cylinder configured to press the cellulose layer against the surface of the moving endless surface in order to realize a contact between the cellulose layer and the grid zone.

The coating layer application device is preferably configured here to interrupt the contact between the cellulose layer and the grid roller.

The coating layer application device preferably comprises a hopper mechanism which couples the pressing cylinder movably to a camshaft which is configured to convert a rotating movement thereof into an up and downward movement of the hopper mechanism, whereby the contact between the cellulose layer and the grid roller is interrupted.

The coating layer preferably comprises an oily compound, such as a paraffin or vegetable oil.

The coating layer is preferably applied in a pattern.

The plurality of recesses preferably take up the coating layer material in capillary manner.

The cellulose packaging material is preferably a bread packaging material for bread bags.

The moving endless surface is preferably a grid roller.

The coating layer preferably has a water vapour permeability lying between 15 and 200 g/m²/day, preferably between 15 and 180 g/m²/day, more preferably between 15 and 150 g/m²/day, still more preferably between 15 and 120 g/m²/day.

The coating layer application device preferably comprises a coating layer material compartment comprising a volume of coating layer material, wherein the grid roller is partially submerged in the volume of coating layer material.

The coating layer application device preferably comprises a further moving endless surface comprising a grid zone with a plurality of recesses which are configured to: take up a predetermined quantity of coating layer material in the plurality of recesses of the grid zone of the further moving endless surface; retain the predetermined quantity of coating layer material in the plurality of recesses of the further moving endless surface; wherein the further moving endless surface is placeable close to the second side of the cellulose layer (10) and is further configured to: apply the predetermined quantity of coating layer material to the second side of the cellulose layer (10) from the plurality of recesses; and form a further coating layer on the second side of the cellulose layer (10) with the predetermined quantity of coating layer material.

According to a third aspect, the invention provides a grid roller for use in the method as described above, optionally in a device as described above, comprising a surface which is provided at least partially with a grid zone comprising a plurality of recesses which are configured to take up a respective predetermined quantity of coating layer material and then apply the coating layer material to a cellulose layer.

According to a fourth aspect, the invention provides a cellulose packaging material wherein a coating layer for setting a moisture vapour permeability of the packaging material is applied according to the above described method, preferably with a device as described above.

According to a fifth aspect, the invention provides a cellulose packaging for foods, such as bread, baked goods, vegetables, fruit, cheese, meat, fish or non-foods, wherein the cellulose packaging is manufactured from a cellulose packaging material as described above.

### BRIEF DESCRIPTION OF THE FIGURES

The above and other advantageous features and objectives of the invention will become more apparent and the invention better understood with reference to the following detailed description when read in combination with the accompanying drawings, in which:

FIG. 1 is a perspective view of a moving endless surface with a grid zone according to an embodiment;

FIG. 2 is a perspective view of the moving endless surface of FIG. 1 and a pressing cylinder;

FIG. 3 is a schematic representation of a grid zone with a first and a second grid zone part and a cellulose layer with a corresponding coating layer according to an exemplary embodiment;

FIG. 4 is a perspective view of a hopper mechanism according to an embodiment;

FIG. 5 is a schematic representation of a grid zone with a first and a second grid zone part and a cellulose layer with a corresponding coating layer according to a further exemplary embodiment;

FIG. 6A is a schematic representation of a method for applying a coating layer according to a preferred embodiment;

FIG. 6B is a side view of a cross-section of a coating layer application device according to a preferred embodiment;

FIGS. 7A1, 7A2, 7B1 and 7B2 illustrate a perspective view of a cellulose packaging manufactured from a cellulose packaging material with a coating layer applied according to the method shown in FIG. 6A and/or using the device shown in FIG. 6B.

### DETAILED EMBODIMENTS

The invention will now be further described on the basis of an exemplary embodiment shown in the drawing.

The same or similar elements are designated in the drawings with the same reference numerals.

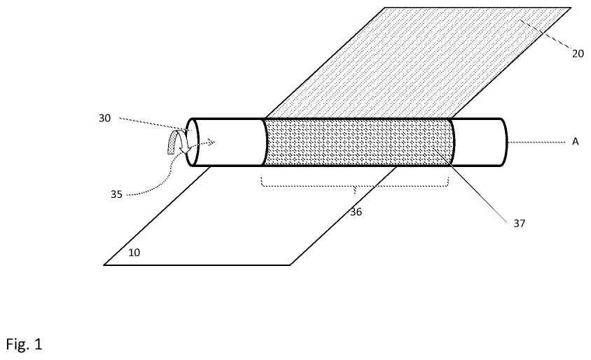

FIG. 1 is a perspective schematic view of a moving endless surface 35 according to a preferred embodiment. The moving endless surface 35 comprises a grid zone 36 with a plurality of recesses 37. FIG. 1 further illustrates that a cellulose layer 10 is provided on the moving endless surface 35 and that a coating layer 20 is applied to the cellulose layer 10.

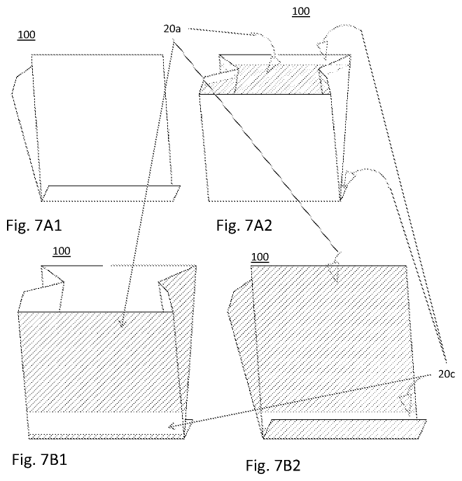

Cellulose layer 10 has a first side, which is visible in FIG. 1, and a second side (not shown). Cellulose layer 10 is intended to function as a cellulose packaging material, for instance a packaging material for bread, baked goods, vegetables, fruit, cheese, meat, fish or non-food products. The packaging material is preferably intended to form a cellulose packaging 100, as illustrated in FIGS. 7A1, 7A2, 7B1 and 7B2. In a preferred embodiment the cellulose layer 10 is substantially formed by a combination of long cellulose fibres and short cellulose fibres.

Cellulose layer 10 is fed to the moving endless surface 35. In the illustrated preferred embodiment the moving endless surface 35 is a roller. The roller comprises a grid zone 36 with a plurality of recesses 37. A grid roller 30 is thus illustrated in the figure. The skilled person will however appreciate that, as an alternative to or in addition to grid roller 30, a conveyor belt can be configured in similar manner.

The recesses 37 are configured to take up coating layer material. A recess 37 is preferably a hollow in the moving endless surface. In other words, a recess is formed by hollowing out the surface. Recess 37 thus extends in a direction away from the surface. The recess has at the position of the surface an inlet opening via which coating layer material can be taken up, the recess preferably having only one inlet opening. The recess can comprise a bottom which lies at a distance from the surface, for instance 1 mm from the surface. The recess can also be formed by forming an upright wall on the surface, although a recess formed in this way is more difficult to produce than hollowing out the surface and also poses a risk of damaging the cellulose layer to be treated. Hollowing out of a recess can for instance be performed with a laser engraving device. The wall can for instance be arranged in grid-like manner the surface in order to form the grid zone. The recess will be further elucidated below. The coating layer material preferably comprises an oily compound, such as a paraffin or vegetable oil. It is favourable to apply a coating layer on the basis of vegetable ingredients, particularly a vegetable oil, such as palm oil, sunflower oil and so on. In this way a cellulose packaging material is obtained which is substantially wholly recyclable, or otherwise compostable. In this way there is furthermore no risk of mineral oil coming into contact with the bread or any other foodstuff in the bag. The vegetable oil preferably comprises a modified vegetable oil with a melting point higher than 40° C., preferably higher than 50° C. and still more preferably higher than 55° C. or 60° ° C. An oil with a melting point of this height ensures that the coating layer on the cellulose layer is in a solid state at room temperature. It will be apparent to the skilled person that the melting point of the modified vegetable oil can be set or selected in accordance with the intended use of the cellulose layer or the packaging material obtained in this way. A cellulose layer with a coating layer comprising a modified oil with a very high melting temperature, for instance sunflower oil with a melting point of 70° C., is thus for instance suitable for being manufactured or stored in an environment wherein the temperature can become very high, for instance 45°, an example of this being use as packaging material for heated snacks. The vegetable oil is preferably selected from the group consisting of: palm oil, soybean oil, sunflower oil, olive oil, almond oil, argan oil, avocado oil, borage seed oil or star flower oil, grapeseed oil, hemp oil, jatropha oil, cottonseed oil, coconut oil, canola oil, linseed oil, macadamia oil, corn oil, palm kernel oil, peanut oil or groundnut oil, rapeseed oil, rice germ oil or rice bran oil, safflower oil, sesame oil, wheat germ oil, evening primrose oil, walnut oil and castor oil, or a mixture thereof. The vegetable oil is more preferably palm oil or sunflower oil or a mixture of palm oil and sunflower oil.

The recesses 37 also allow the use of coating layer materials with a high viscosity. Compared to known systems which typically use a coating layer material with a low viscosity, for instance 1 mPa·s or lower, recesses 37 allow the use of coating layer materials with a high viscosity. The viscosity of the coating layer materials preferably lies in the range of 10-500 mPa·s. As an example, the comparison can be made that known systems use a coating layer material having a viscosity similar to that of water or lower, and that the recesses 37 allow the use of coating layer material having a viscosity similar to that of honey or higher. The inventor has found that a dangerous situation, wherein the coating layer material starts to swell during rotation therein of endless surface 35, is lessened to considerable extent. This is because the swirling forms a dangerous situation wherein the coating layer material splashes out of the container. The increased viscosity counteracts the swirling of the coating layer material, whereby the method and the device for applying the coating layer are safer.

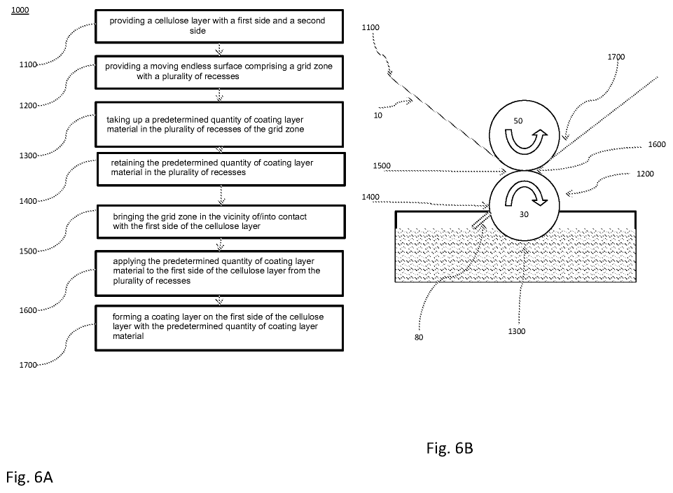

Taking up of the coating layer material in recesses 37 is preferably performed in capillary manner. The coating layer material is as it were sucked into recesses 37 from a coating layer material container by means of capillary action. In other words, the recesses 37 suck the coating layer material from a coating layer material container into their respective cavities. The taking up of the coating layer material will be further discussed at length with reference to FIG. 6. Alternatively or additionally, the coating layer material can be carried via a channel in the moving endless surface to a position at the recesses 37. Alternatively or additionally, the coating layer material can be poured onto the recesses.

The recesses 37 are arranged in a surface of the grid roller 30. Recesses 37 can have different forms and also mutually differing forms. A recess 37 can thus for instance have a pyramidal form, such as a simplex or tetrahedron (not shown). The recess can alternatively or in combination also be a spherical, cylindrical or hexahedral recess (not shown). A dimension of the recesses 37 determines a quantity of coating layer material which will be taken up. The dimensions of the plurality of recesses are thus chosen such that the coating layer has a weight lying in the range of 10-12 g/m², more preferably in the range of 8-10 g/m², most preferably in the range of 1-8 g/m². The dimensions of the recesses are preferably selected depending on the coating layer material to be applied. Research by the inventor has shown that the moisture vapour permeability is sigmoidally proportional to the applied quantity of coating layer material. Sigmoidally proportional is understood to mean that the moisture vapour permeability of the cellulose packaging material describes an S-shaped course as a function of the applied quantity of coating layer material. More specifically, sigmoidally is understood to mean a logistic function. A coating layer with a weight of 1-8 g/m² thus has an acceptable moisture vapour permeability, for instance 200 g/m²/day. It is noted that the moisture vapour permeability is highly dependent on the type of cellulose layer and the coating layer material. The coating layer with a weight of 1-8 g/m² further has relatively good adhesion characteristics relative to the moisture vapour permeability. Such a coating layer is moreover cheaper compared to a coating layer wherein more coating layer material is applied. It will further be apparent that these characteristics depend on the type of cellulose layer, the quantity of coating layer and the type of coating layer, and that they also have a mutual influence on each other. The inventor has further found that a coating layer with a weight of 10-12 g/m² approaches a minimal moisture vapour permeability in asymptotic manner. An optimal moisture vapour permeability is thus achieved when a coating layer with a weight of 10-12 g/m² is applied. Approaching the optimal moisture vapour permeability in asymptotic manner is understood to mean that application of a coating layer with a weight higher than 12 g/m² has almost no favourable effect on the moisture vapour permeability thereof, and is furthermore expensive. Surprisingly, the inventor has found that when the dimension of the plurality of recesses corresponds with a coating layer having a weight of 1-8 g/m², such packaging material has the most optimal combination of characteristics, both commercially and in terms of quality. It is further noted that the coating layer can be applied on one side or on two sides of the paper, in the same or different quantities. 1 g/m² of coating layer material can thus for instance be applied to a first side and 10 g/m² to the second side. Alternatively, it is also possible to apply 5 g/m² of coating layer material on each side of the cellulose material so that 10 g/m² of coating layer material will have been applied in total. Tests have however shown that it is more efficient to provide just one side with 10 g/m² of coating layer material. The coating layer preferably has a moisture vapour permeability lying between 15 and 200 g/m²/day, preferably between 15 and 180 g/m²/day, more preferably between 15 and 150 g/m²/day, still more preferably between 15 and 120 g/m²/day, wherein the vapour permeability is measured in accordance with DIN 53-122-1 at 25° C. and at 75% relative humidity. This low vapour permeability is favourable because it makes paper bags an effective alternative to conventional plastic bread bags, which have a vapour permeability of about 15 g/m²/day. The moisture vapour permeability or vapour permeability is also known in the field as the MVTR (moisture vapour transmission rate). In the context of this application reference is synonymously made to moisture vapour permeability and vapour permeability. It is however noted that, by applying the coating layer, not only is a moisture vapour permeability of the packaging material set, but a fat permeability is also set. This means that the coating layer also forms a barrier to fats. In the context of this application reference is made to the moisture vapour permeability, but it will also be apparent that a fat permeability is controlled.

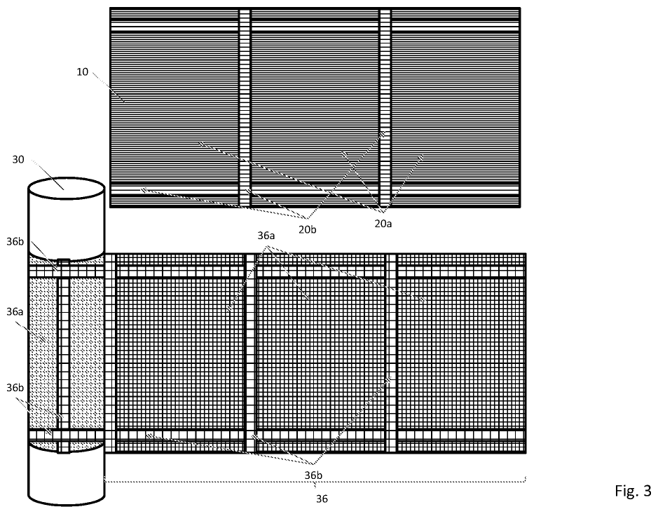

A plurality of recesses 37 together form a grid zone 36. The plurality of recesses 37 are preferably applied in the surface 35 of grid roller 30 in a repetitive pattern. The plurality of recesses of grid zone 36 preferably have the same form. This allows application of a uniform coating layer over a whole dimension of the grid zone. The grid zone will be further discussed at length with reference to FIG. 3.

Grid roller 30 is movable about its axis, as seen in a longitudinal direction of grid roller 30. In other words, a moving endless surface is formed by rotating grid roller 30 about its axis A. As illustrated in FIG. 6, the grid roller can thus take up and retain coating layer material and apply it to the cellulose layer with one rotation about its axis A.

FIG. 1 further illustrates that grid zone 36 is in contact with the first side of the cellulose layer 10. By bringing cellulose layer 10 into contact with grid zone 36 the predetermined quantity of coating layer material is applied to the first side from the plurality of recesses 37. A coating layer 20 is thus formed on the first side of cellulose layer 10, wherein the quantity of coating layer material used in coating layer 20 is advantageously known beforehand. Coating layer 20 is preferably applied to the more closed side of the paper. It is further also noted that the device can also be utilized for application of a coating layer to cardboard. Cardboard is also a cellulose layer which can be fed. Typically provided on one side of the cardboard is a coating where the cardboard will absorb little or almost no coating layer material. Coating layer material can however be applied as described above to the other side of the cardboard in efficient manner.

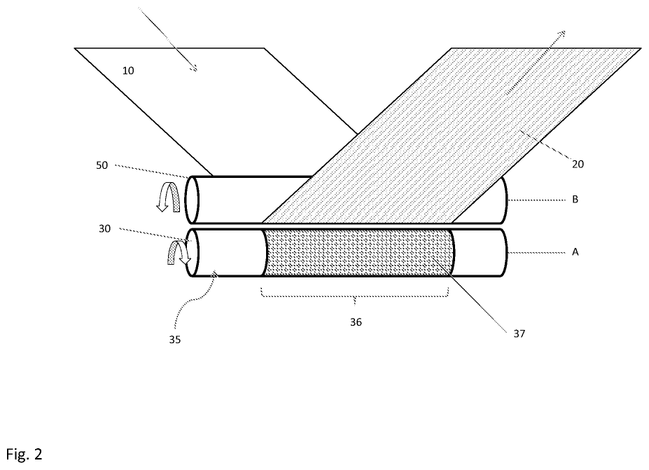

FIG. 2 is a perspective view of the grid roller 30 of FIG. 1, wherein a pressing cylinder 50 presses the cellulose layer 10 against the grid zone and/or the grid roller 30. This is favourable because the applied coating layer 20 thereby penetrates even further into the cellulose layer. FIG. 2 further illustrates that cellulose layer 10 can be fed to grid roller 30 in different ways. Cellulose layer 10 can thus be fed at an angle relative to grid roller 30 or pressing cylinder 50. Cellulose layer 10 can for instance be fed at an angle of 90° or at an angle of 45° relative to a horizontal plane. The cellulose layer 10 which is fed at an angle of 90° will share a greater contact surface with pressing cylinder 50. Cellulose layer 10 is fed from a downstream direction. A coating layer is then applied and cellulose layer 10 is discharged at an angle. Cellulose layer 10 is here prevented from sagging onto grid roller 30, whereby the coating layer can be applied in optimal manner. This further also allows a coating layer application device to be configured more compactly.

FIG. 3 illustrates a grid roller 30 which is provided with a grid zone 36 with a first grid zone part 36a and a second grid zone part 36b. Further illustrated for the purpose of elucidation is an unwound top view of an outer surface of grid roller 30. A cellulose layer 10 with a coating layer obtained by bringing cellulose layer 10 into contact with the illustrated grid zone is illustrated similarly to the unwound outer surface. The coating layer comprises a first coating layer zone 20a and second coating layer zone 20b similar to respectively the first grid zone part 36a and the second grid zone part 36b.

The first and second grid zone parts 36a, 36b comprise respectively a plurality of first recesses and a plurality of second recesses, which take up, retain and apply respectively a first predetermined quantity of coating layer material and a second predetermined quantity of coating layer material. In the illustrated preferred embodiment the first grid zone part 36a comprises more recesses than the second grid zone part 36b. This is illustrated on the basis of the grid of squares shown in the figure, wherein it will be apparent that more squares are present in the first grid zone part 36a than in the second grid zone part 36b. By changing the number of recesses the quantity of coating layer material which is taken up, retained and applied can be controlled.

The first grid zone part 36a thus takes up a first predetermined quantity of coating layer material and then applies it to the cellulose layer so that the first coating layer zone 20a is formed in accordance with the first predetermined quantity of coating layer material. Similarly to the foregoing, the second grid zone part 36b applies a second predetermined quantity of coating layer material to the cellulose layer 10 so that the second coating layer zone 20b is formed. The quantity of coating layer material which is applied is illustrated on the basis of the amount of lines in the respective coating layer zones 20a, 20b. It will thus be apparent that the first predetermined quantity of coating layer material differs from the second predetermined quantity of coating layer material.

The plurality of first recesses and plurality of second recesses are further configured to take up, retain and apply respectively a first predetermined quantity of coating layer material and a second predetermined quantity of coating layer material. As described above, the first predetermined quantity of coating layer material differs from the second predetermined quantity of coating layer material. An alternative manner of controlling the quantity of coating layer material taken up, retained and applied is realized by changing the dimensions and/or the form of the recesses. As a result, the predetermined quantity of coating layer material for each recess, and therefore also for each grid zone part 36a, 36b, is adjustable by increasing or decreasing the dimension of the recesses. It will be apparent that both the dimensions of the recesses and the number of recesses have an effect on the quantity of coating layer material taken up, retained and applied. On the one hand, it will be apparent that the quantity of coating layer material applied as coating layer is always known beforehand. On the other hand, it will be apparent that the moisture vapour permeability of the final cellulose packaging material is hereby controllable. In the illustrated embodiment of FIG. 3 the first grid zone part 36a applies more coating layer material to cellulose layer 10 than the second grid zone part 36b. The coating layer at the position of first coating layer zone 20a will thus comprise more coating layer material than the coating layer at the position of second coating layer zone 20b. The coating layer in first coating layer zone 20a will therefore be less moisture-permeable than the coating layer in second coating layer zone 20b. As indicated above, such an embodiment is advantageous because the cellulose layer can be adhered in optimal manner at the position of the second coating layer zone 20b and because the moisture vapour permeability is minimal at the position of the first coating layer zone 20a. The cellulose packaging material thus comprises optimal properties for being processed further and to function depending on the intended object. The skilled person will appreciate on the basis of the above that the quantity of coating material can therefore be controlled in different ways. On the one hand, the quantity of coating layer material is controllable using a dimension and/or the form of the recesses. On the other hand, the quantity of coating layer material is controllable by changing the number of recesses. It will further also be apparent that controlling the quantity of coating layer material is also possible by a combination of controlling the dimension and the number of recesses. According to a preferred embodiment, the recesses are arranged on the grid roller along a plurality of rows. A row is for instance formed by a plurality of recesses lying in the same line, wherein the line is parallel to the axis of the grid roller 30 and extends between the two outer ends of grid roller 30. The row comprises a plurality of recesses. It will be apparent that the number of recesses per row depends on the size of the grid roller. In order to be able to better quantify the number of recesses reference is made in the application to number of recesses per running centimetre, abbreviated to LPCM, as seen along an outer surface of the grid roller. A minimum of eight recesses are preferably arranged per running centimetre, or eight LPCM. A maximum of two hundred and forty recesses are preferably arranged per running centimetre, or two hundred and forty LPCM. As described above, a dimension and/or form of the recess can be changed in order to control the quantity of applied coating layer material. The recesses preferably comprise a total volume of a minimum of 3 cm³ of coating layer material applied per square metre of cellulose layer 10, in other words, the recesses preferably comprise a volume of a minimum of 5 cm³/m². According to an embodiment, the grid roller has two hundred and forty LPCM, i.e. two hundred and forty recesses per running centimetre, these having a joint volume of a minimum of 3 cm³/m², more preferably a joint volume of a minimum of 5 cm³/m². The inventor has found that the joint volume is a maximum of 9 cm³/m² in such a preferred embodiment. According to a further preferred embodiment, the grid roller has eight LPCM having a joint volume of a minimum of 40 cm³/m², more preferably a joint volume of a minimum of 70 cm³/m². The inventor has found that the joint volume is a maximum of 120 cm³/m² in such a preferred embodiment. In practice the number of recesses also limits the dimensions thereof. It will thus be apparent that a grid roller with two hundred and forty LPCM has smaller recesses compared to a grid roller with eight LPCM when it must apply the same quantity of coating layer material. According to further exemplary embodiments, the grid roller comprises thirty, sixty, eighty, a hundred or a hundred and forty LPCM. According to a preferred embodiment, the joint volume of the recesses of the grid roller with thirty, sixty, eighty, a hundred or a hundred and forty LPCM has a respective minimum of 15 cm³/cm², 11 cm³/m², 8 cm³/m², 5.5 cm³/m², 4 cm²/m², preferably a respective minimum of 40 cm³/cm², 17 cm³/m², 13 cm³/m², 12 cm³/m², 8 cm³/m². The grid roller with thirty, sixty, eighty, a hundred or a hundred and forty LPCM with a respective minimum volume of 40 cm³/cm², 17 cm³/m², 13 cm³/m², 12 cm³/m², 8 cm³/m² applies for instance respectively 13.5 g/m², 8 g/m², 5 g/m², 4.3 g/m², 3.5 g/m² of coating layer material to the cellulose layer.

It will be apparent that the location of the grid zone parts 36a, 36b must be set depending on the intended object of the cellulose packaging material. It will further also be apparent that further grid zone parts, for instance a third grid zone part (not shown), can be provided. The third grid zone part can thus for instance apply a quantity of coating layer material which lies between the quantity of the first grid zone part and the second grid zone part. As described above, the coating layer hardens when it dries. When the coating layer is dry and the cellulose packaging material is then folded, a fracture results in the coating layer. This fracture is moisture-permeable, whereby the cellulose packaging material may leak at the position of the fracture. By applying at a position of fold lines, e.g. at the position of a third grid zone part, a quantity of coating layer material lying intermediately relative to the first and second grid zones the chance of the coating layer fracturing is reduced, and moisture will be stopped after all. The cellulose packaging material can thus be produced optimally depending on the intended object thereof.

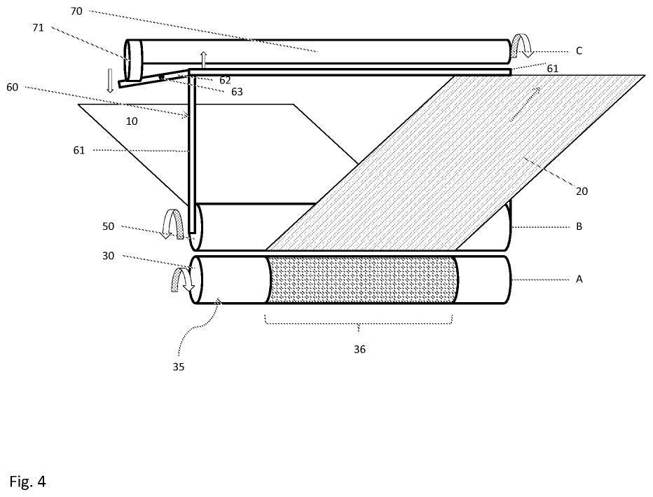

FIG. 4 illustrates a perspective view of a grid roller 30 according to a further preferred embodiment. Cellulose layer 10 is pressed against the grid zone 36 of grid roller 30 using a pressing cylinder 50. Pressing cellulose layer 10 against grid zone 36 allows the coating layer material to be applied in advantageous manner.

Pressing cylinder 50 is rotatable about an axis (not shown) and, in the illustrated embodiment, is movable in a height direction. More specifically, pressing cylinder 50 is coupled movably to a camshaft 70 via a hopper mechanism 60.

Camshaft 70 is rotatable about an axis C. Camshaft 70 comprises an eccentric camshaft part 71. The eccentric camshaft part 71 extends eccentrically from the outer surface of camshaft 70 outward. The eccentric camshaft part 71 co-rotates with camshaft 70. Camshaft 70 is preferably drivable by an actuator such as a servomotor.

According to the illustrated embodiment, the hopper mechanism 60 comprises a frame 61. Pressing cylinder 50 is mounted in frame 61 for rotation about an axis B. Frame 61 is further coupled to camshaft 70 via a tilting mechanism. The tilting mechanism comprises a tilting bar 62. Tilting bar 62 is tiltable about a tilt axis 63 and comprises two tilting bar arms extending in two opposite directions from tilt axis 63. A first arm of tilting bar 62 is connected to frame 61. A second arm of tilting bar 62 extends to a position under the camshaft part and to a position in a plane of movement of camshaft part 71. By rotating camshaft 70 the camshaft part 71 will function during a rotation thereof as stop surface which moves the second arm downward. The downward movement of the second arm rotates the tilting bar around the tilt axis 63, whereby the first arm is moved upward. The upward movement of the first arm then lifts frame 61 in upward direction, whereby the pressing cylinder 50 is finally lifted up. Lifting up of the pressing cylinder results in the contact between the cellulose layer and grid roller 30 being broken. In other words, the rotating movement of camshaft 70 is converted into an up and downward movement of the hopper mechanism whereby the contact between the cellulose layer and the moving endless surface is interrupted. It will be apparent that the up and downward movement is only temporary due to the eccentric camshaft part, i.e. the interruption is realized for as long as camshaft part 71 makes contact with the first arm of tilting bar 62. Such a camshaft and hopper mechanism can be integrated retroactively and in relatively simple manner in an existing coating layer application device. A frequency of the interruption can moreover be further controlled by providing a plurality of camshaft parts. A first camshaft part and a second camshaft part can for instance be directed at right angles relative to each other. A contact moment between the camshaft parts and second arm of the tilting bar is determined at least partially by the rotation speed of the camshaft. A frequency of the interruption can thus be controlled by adjusting a mutual angle between different camshaft parts.

It will further be apparent to the skilled person that there are different ways of breaking the contact between cellulose layer 10 and grid roller 30. It has thus been found that the interruption can also be realized by interrupting the grid zone 36, for instance in that grid roller 30 is provided with a blank zone which applies no coating layer material to cellulose layer 10.

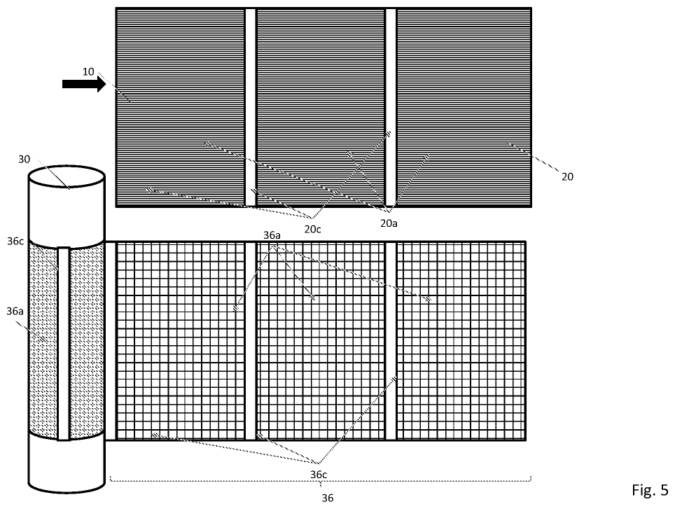

FIG. 5 illustrates a grid roller which is provided with a blank zone 36c. Grid zone 36 is further illustrated for the purpose of elucidation as an unwound top view of an outer surface of grid roller 30. A cellulose layer 10 with a coating layer obtained by bringing cellulose layer 10 into contact with the illustrated grid zone is illustrated similarly to the unwound outer surface.

In other words, FIG. 5 illustrates the result of the interruption of the application of coating layer 10. Interrupting the application creates a zone 20c on the cellulose layer where no coating material is present. The zone 20c where no coating layer material is present strengthens an adhesive connection applied or to be applied there to a considerable extent. The strengthened glue connection allows the cellulose packaging material to be used for more, larger and/or heavier products.

FIGS. 3 and 5 further illustrate that the coating layer 10 is preferably applied in a pattern. The pattern of the coating layer preferably comprises repetitive elements. The repetitive elements still more preferably lie at a uniform distance from each other, whereby a pattern of lines and intermediate spaces results. The perpendicular distance between the repetitive elements is further preferably a maximum of 4 times greater than the width of the repetitive elements. The perpendicular distance is still more preferably a maximum of 3 times or even a maximum of 2 times the width of the repetitive elements. It has further been found that when applying a coating layer with a uniform pattern, such as the pattern of parallel lines at uniform mutual distances illustrated in FIG. 5, the lines nevertheless do not have a wholly uniform width after application of the coating layer. In other words, the lines have a slight variation. This effect is particularly achieved in somewhat rougher types of paper, such as for instance unbleached paper with a higher percentage of long fibres. Such paper types typically have a surface roughness on the first side of 100-250 ml/min (ISO 8791-2), such as 150-200 ml/min. Such a slight variation gives the appearance that the pattern is actually located in the paper, rather than lying on it. Instead of and/or in addition to a regularly repetitive element, a watermark can also be arranged in this way.

FIG. 6A illustrates a method 1000 for applying a coating layer to a cellulose packaging material for the purpose of setting a moisture vapour permeability of the packaging material. FIG. 6B illustrates the method 1000 in a coating layer application device according to a preferred embodiment.

In a first step the method comprises providing 1100 a cellulose layer 10 with a first side and a second side. As already illustrated in FIGS. 1, 2 and 4, the cellulose layer 10 can be fed in multiple ways and from multiple directions. The method further comprises the step of providing 1200 a moving endless surface comprising a grid zone with a plurality of recesses. In the illustrated embodiment the moving endless surface is a grid roller 30. The grid roller 30 is submerged at least partially in a container for coating layer material. Grid roller 30 here takes up 1300 a predetermined quantity of coating layer material in the plurality of recesses of the grid zone. Taking up of the coating layer material takes place via the inlet opening of recess 37, i.e. at the position of the surface. The predetermined quantity of coating layer material is then retained 1400 in the plurality of recesses. Optionally provided is a blade 80 which is arranged with a peripheral edge thereof against or substantially against the outer surface of grid roller 30 in order to scrape excess taken-up coating layer material off the outer surface. The grid zone is then brought into contact 1500 with the first side of cellulose layer 10. In FIG. 6B the grid zone is brought into contact via an underside of the cellulose layer. It will however be apparent that the grid zone can also be situated on the upper side of the cellulose layer. The predetermined quantity of coating layer material is applied 1600 from the plurality of recesses when the cellulose layer is brought into contact with the grid zone. In other words, the coating layer material thus also leaves the recess via the inlet opening thereof. Taking up the coating layer material in the recesses and applying the coating layer material from the recesses thus takes place via the same side of the recess, i.e. at the position of the surface. A coating layer is hereby formed 1700 on the cellulose layer 10 with the predetermined quantity of coating layer material.

Owing to the above described improved controllability of the application of the coating layer material, the method and the device allow existing devices to be utilized in more flexible manner. The coating layer material can thus be held in the device and applied at lower temperature, for instance 120° C. The advantage hereof is based on the insight that coating layer materials give off a very unpleasant smell at higher temperatures, for instance 150° ° C. Keeping the coating layer material at a lower temperature, preferably a maximum of 130° C., more preferably a maximum of 120° C., makes an area surrounding the device more accessible and pleasant. Less energy is further needed to heat the coating layer material to 120° C. compared to 150° C. The improved application of the coating layer material also gives the user more freedom to use different pressures, e.g. more or less pressure, compared to known systems or devices.

The improved application of the coating layer material can also be used to apply a predetermined quantity of coating layer material to the second side. A predetermined quantity of coating layer material can be applied to both the first side and the second side of cellulose layer 10. In other words, a predetermined quantity of coating layer material can be applied to the first side and/or the second side of the cellulose layer. A first moving endless surface, as shown in FIG. 1, can be provided and a second moving endless surface (not shown) can be provided for this purpose. The first moving endless surface 35 can for instance apply the coating layer material to the first side, as elucidated above. The second endless surface (not shown) is provided to apply a predetermined quantity of coating layer material to the second side. The quantity of coating layer material which is applied by the first moving endless surface on one side and by the second moving endless surface on the other is not necessarily the same. The first and the second moving endless surface can for instance be provided with grid zones which differ from each other. It is noted that the type of coating layer material on the first and second side can also be different. Experiments have thus shown that an oily coating layer material can be provided on the first side and an aqueous material can be provided on the second side. The second moving endless surface is preferably situated downstream, as seen in a direction of movement of the coating layer 10, of the first moving endless surface.

FIGS. 7A1, 7A2, 7B 1 and 7B2 illustrate a perspective view of a cellulose packaging 100 manufactured from a cellulose packaging material with a coating layer 20 which is applied using method 1000 shown in FIGS. 6A and 6B.

FIGS. 7A1 and 7A2 show a front side and rear side of a cellulose packaging formed from a cellulose packaging material. The packaging illustrated in FIGS. 7A1 and 7A2 is a bag with a coating layer 20a on an inward-facing side of the bag. As described above, the method allows for no coating layer material to be applied to a portion of the packaging material. The zone 20c where no coating layer material is present considerably strengthens an adhesive connection applied or to be applied there. Zone 20c allows the cellulose packaging material to be adhered to itself or to a further packaging material. In the illustrated preferred embodiment a bag with a strong bottom is formed in this way because the zone 20c realizes an improved adhesion and thus reinforces the bottom. FIGS. 7B1 and 7B2 show a front side and rear side of a cellulose packaging which is formed from a cellulose packaging material. Similarly to FIGS. 7A1 and 7A2, FIGS. 7B1 and 7B2 show a bag. FIGS. 7A1, 7A2 and 7B1, 7B2 however differ in that a coating layer 20a is arranged on an outward-facing side of the bag in FIGS. 7B1 and 7B2. It will be apparent to the skilled person that further packagings, such as cardboard boxes for for instance cakes, pastries or hamburgers, holders such as a cupholder for coffee or carrying trays for for instance eggs, can be manufactured from a cellulose packaging material made on the basis of the above described method. It will further be apparent that a coating layer can be applied on both the inner side and the outer side of the bag in the illustrated context of FIGS. 7A1, 7A2, 7B1, 7B2.

The skilled person will appreciate on the basis of the above description that the invention can be embodied in different ways and on the basis of different principles. The invention is not limited here to the above described embodiments. The above described embodiments and the figures are purely illustrative and serve only to increase understanding of the invention. The invention is not therefore limited to the embodiments described herein, but is defined in the claims.

1. Method for applying a coating layer to a cellulose packaging material for the purpose of setting a moisture vapour permeability of the packaging material, comprising:
providing a cellulose layer with a first side and a second side;
providing a moving endless surface which comprises a grid zone with a plurality of recesses;
taking up a predetermined quantity of coating layer material in the plurality of recesses of the grid zone;
retaining the predetermined quantity of coating layer material in the plurality of recesses;
bringing the grid zone into contact with the first side of the cellulose layer;
applying the predetermined quantity of coating layer material to the first side of the cellulose layer from the plurality of recesses; and
forming a coating layer on the first side of the cellulose layer (10) with the predetermined quantity of coating layer material.

2. Method according to claim 1, wherein the grid zone comprises a first grid zone part and a second grid zone part comprising respectively a plurality of first recesses and a plurality of second recesses which take up, retain and apply respectively a first predetermined quantity of coating layer material and a second predetermined quantity of coating layer material, wherein the first predetermined quantity of coating layer material differs from the second predetermined quantity of coating layer material.

3. Method according to claim 1, wherein the moving endless surface is further provided with a blank zone which applies no coating layer material to the first side of the cellulose layer.

4. Method according to claim 1, wherein a dimension of the plurality of recesses is such that the coating layer has a weight lying in the range of 10-12 g/m², more preferably lying in the range of 8-10 g/m², most preferably lying in the range of 1-8 g/m².

5. Method according to claim 1, wherein bringing the grid zone into contact with the first side of the cellulose layer comprises pressing the first side of the cellulose layer against the grid zone of the moving endless surface.

6. Method according to claim 1, wherein the pressing is performed by means of a pressing cylinder.

7. Method according to claim 5, further comprising interrupting the application of the predetermined quantity of coating layer material to the first side of the cellulose layer.

8. Method according to claim 7, wherein interrupting application of the coating layer to the first side of the cellulose layer comprises interrupting bringing the grid zone into contact with the first side of the cellulose layer.

9. Method according to claim 7, wherein interrupting application of the predetermined quantity of coating layer material to the first side of the cellulose layer is performed using a hopper mechanism which couples the pressing cylinder movably to a camshaft which is configured to convert a rotating movement thereof into an up and downward movement of the hopper mechanism, whereby the contact between the cellulose layer and the moving endless surface is interrupted.

10. Method according to claim 1, wherein the coating layer comprises an oily compound, such as a paraffin or vegetable oil.

11. Method according to claim 1, wherein the coating layer is applied in a pattern.

12. Method according to claim 1, wherein taking up of the predetermined quantity of coating layer material in the plurality of recesses of the grid zone comprises taking up the coating layer material in the recesses in capillary manner.

13. Method according to claim 1, wherein the cellulose packaging material is a bread packaging material for bread bags.

14. Method according to claim 1, wherein the moving endless surface is a grid roller.

15. Method according to claim 1, wherein the coating layer has a moisture vapour permeability lying between 15 and 200 g/m²/day, preferably between 15 and 180 g/m²/day, more preferably between 15 and 150 g/m²/day, still more preferably between 15 and 120/day.

16. Method according to claim 1, further comprising:
providing a further moving endless surface which comprises a grid zone with a plurality of recesses;
taking up a predetermined quantity of coating layer material in the plurality of recesses of the grid zone of the further moving endless surface;
retaining the predetermined quantity of coating layer material in the plurality of recesses of the further moving endless surface;
bringing the grid zone into contact with the second side of the cellulose layer;
applying the predetermined quantity of coating layer material to the second side of the cellulose layer from the plurality of recesses of the further moving endless surface; and
forming a further coating layer on the second side of the cellulose layer with the predetermined quantity of coating layer material.

17. A coating layer application device for setting a moisture vapour permeability of a cellulose packaging material, comprising a moving endless surface for applying a coating layer to the cellulose packaging material, wherein the cellulose packaging material comprises a cellulose layer with a first side and a second side, wherein the cellulose layer moves through the coating layer application device in a direction of movement, wherein the moving endless surface comprises a grid zone with a plurality of recesses which are configured to:
take up a predetermined quantity of coating layer material in the plurality of recesses of the grid zone;
retain the predetermined quantity of coating layer material in the plurality of recesses;
wherein the moving endless surface is placeable close to the first side of the cellulose layer and is further configured to:
apply the predetermined quantity of coating layer material to the first side of the cellulose layer from the plurality of recesses; and
form a coating layer on the first side of the cellulose layer with the predetermined quantity of coating layer material.

18. The coating layer application device according to claim 1, wherein the grid zone comprises a first grid zone part and a second grid zone part comprising respectively a plurality of first recesses and a plurality of second recesses which take up, retain and apply respectively a first predetermined quantity of coating layer material and a second predetermined quantity of coating layer material, wherein the first predetermined quantity of coating layer material differs from the second predetermined quantity of coating layer material.

19-33. (canceled)

34. A cellulose packaging material wherein a coating layer for setting a moisture vapour permeability of the packaging material is applied according to the method according to claim 1.

35. A cellulose packaging for foods comprising bread, baked goods, vegetables, fruit, cheese or meat, or non-foods, wherein the cellulose packaging is manufactured integrally from a cellulose packaging material according to claim 34.
